(19) United States
(12) Patent Application Publication
(10) Pub. No.: US 2020/0307481 A1
(43) Pub. Date: Oct. 1, 2020

(54) AIRBAG ELECTRONIC CONTROLLER UNIT

(71) Applicant: ZF ACTIVE SAFETY AND ELECTRONICS US LLC, Livonia, MI (US)

(72) Inventors: GRIGORY YEZERSKY, Farmington Hills, MI (US); WILLIAM C. FRIGON, Novi, MI (US); THOMAS J. GUNTHER, Canton, MI (US); ANUJ SHAH, Ann Arbor, MI (US); VITALIY SELEKTOR, Franklin, MI (US); ERIK ROMZEK, Northville, MI (US)

(21) Appl. No.: 16/367,425

(22) Filed: Mar. 28, 2019

(51) Int. Cl. B60R 21/017; B60R 21/013

(52) U.S. Cl. CPC B60R 21/017; B60R 2021/01129; B60R 21/013

(57) ABSTRACT

An airbag electronic control unit for a vehicle includes a main controller unit (MCU) for, in response to detecting a vehicle event, actuating at least one protection device in the vehicle. A battery is provided for receiving power from the vehicle to power the MCU such that power to the MCU is continuous.

### TECHNICAL FIELD

This disclosure relates to a vehicle safety system and, in particular, relates to an airbag electronic controller unit (ECU) with features for maintaining power in emergency situations.

### BACKGROUND

It is known to provide a vehicle safety system including one or more actuatable vehicle occupant protection devices, such as airbags, for helping to protect an occupant upon the occurrence of an event for which occupant protection is desired, such as a vehicle impact, a vehicle rollover, collectively referred to herein as a “vehicle crash.” Such safety systems include an airbag ECU and crash sensors (e.g., accelerometers, pressure sensors, inertia sensors) positioned at various locations throughout the vehicle, such as the front, rear, sides, and center of gravity. The crash sensors are electrically connected (e.g., via wired connections or data/power bus connections) to the airbag ECU to provide data related to sensed vehicle conditions, which the airbag ECU uses to determine that the type of crash that has occurred and which, if any, of the protection devices to actuate.

In addition to electrical connections with the various crash sensors, the airbag ECU can also include electrical connections (e.g., wired or bus connections) to other vehicle systems, such as an occupant classification ECU, which obtains occupant data via sensors, such as seatbelt buckle switches, seat weight sensors, seat position sensors, occupant presence sensors, etc. Data obtained from the occupant classification ECU can be used for occupant discrimination, i.e., to determine the presence, type, position, etc. of the occupant and/or the occupant seat so that actuation/deployment of the protection device can be tailored accordingly.

The airbag ECU can also be electrically connected to other occupant safety systems, such as antilock braking systems (ABS), chassis control systems, stability control systems, traction control systems, skid control systems, collision avoidance systems, tire pressure monitoring systems (TPMS), radars, cameras, and other environment monitoring components, all of which can potentially be used to inform the airbag ECU of vehicle conditions prior to or at the time of a crash. The airbag ECU can also be electrically connected to vehicle instrumentation (speed, etc.), navigation systems, and communication systems.

The vehicle system connections with the airbag ECU can be direct or indirect. For direct connections, the system can be wired directly to the airbag ECU, for example, via cable or twisted pair bus connection. This may be the case, for example, with occupant classification ECU, where the provided signal can directly affect airbag deployment. The connection between the airbag ECU and the occupant classification ECU can, for example, be a bus connection, such as a vehicle local interconnect network (LIN) bus connection.

For indirect connections, the system can be electrically connected (e.g., wired or bus connection) to a central controller, such as a vehicle body control module (BCM), which is, in turn, connected to the other vehicle systems. This may be the case, for example, with the antilock braking systems (ABS), chassis control systems, stability control systems, traction control systems, skid control systems, collision avoidance systems, and tire pressure monitoring systems (TPMS). The connection between the airbag ECU and the BCM can, for example, be a bus connection, such as a vehicle controller area network (CAN) bus connection.

### SUMMARY

In one example, an airbag electronic control unit for a vehicle includes a main controller unit (MCU) for, in response to detecting a vehicle event, actuating at least one protection device in the vehicle. A battery is provided for receiving power from the vehicle to power the MCU such that power to the MCU is continuous.

In another example, a method of operating an airbag ECU includes detecting a vehicle crash event with a MCU. At least one protection device in the vehicle is actuated with a capacitor on the airbag ECU in response to detecting the crash event. The airbag ECU is powered with a battery charged by a vehicle battery such that power to the MCU is continuous.

In another example, a method of operating an airbag ECU includes supplying power to the ECU from a power supply outside the ECU. It is determined when power from the power supply is lost. Power from is directed a battery on-board the ECU to the ECU to maintain continuous operation of the ECU.

### BRIEF DESCRIPTION OF THE DRAWINGS

For a better understanding, reference may be made to the accompanying drawings, in which:

FIG. 1 is a schematic illustration of a vehicle safety system implemented in a vehicle.

FIG. 2 is a block diagram of the vehicle safety system.

FIG. 3 is a flowchart of an example method of powering an airbag ECU when vehicle power is lost.

### DESCRIPTION OF EMBODIMENTS

This disclosure relates to a vehicle safety system and, in particular, relates to an airbag ECU with features for maintaining power in emergency situations. In this description of a vehicle safety system, reference is sometimes made to the left and right sides of a vehicle. These references should be understood as being taken with reference to the forward direction of vehicle travel. Thus, reference to the “left” side of a vehicle is meant to correspond to a driver side of the vehicle. Reference to the “right” side of the vehicle is meant to correspond to a passenger side of the vehicle.

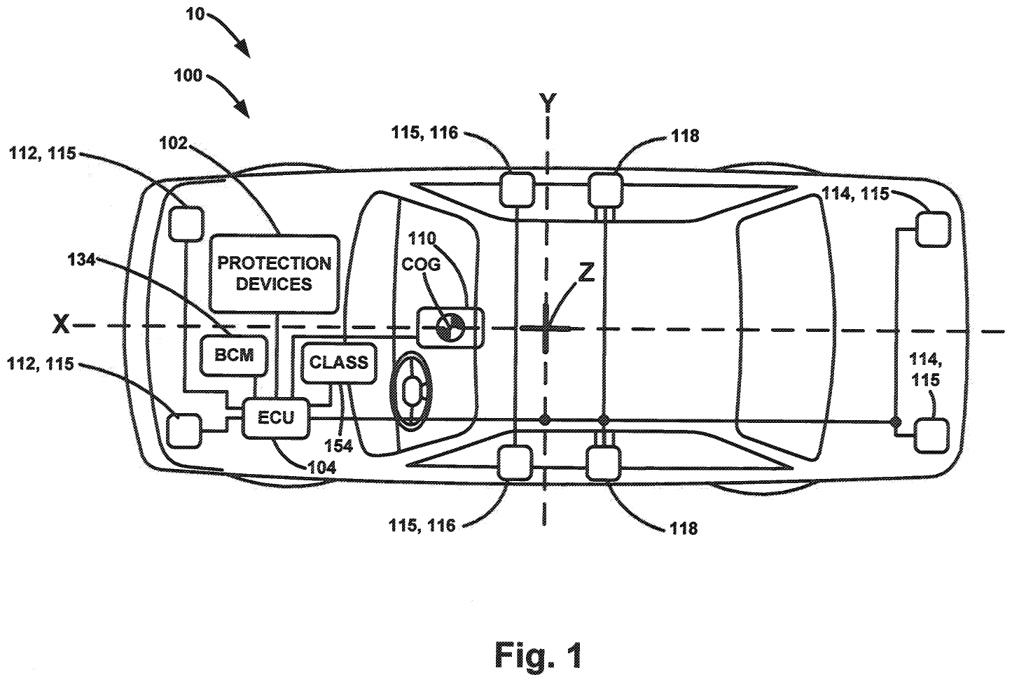

Referring to FIG. 1, a vehicle 10 includes a vehicle safety system 100. The vehicle safety system 100 includes one or more actuatable vehicle occupant protection devices, which are illustrated schematically at 102. The protection devices 102 can include any actuatable vehicle occupant protection device, such as frontal airbags, side airbags, curtain air bags, knee bolster air bags, actuatable seatbelt pre-tensioners and/or retractors. The vehicle safety system 100 also includes an airbag electronic control unit (ECU) 104 operatively connected to the protection devices 102. The airbag ECU 104 is operative to control actuation of the protection devices 102 in response to vehicle conditions sensed via one or more sensors operatively connected to the airbag ECU.

The vehicle safety system 100 includes several sensors for measuring certain conditions of the vehicle 10 that are utilized to determine whether to actuate the vehicle occupant protection device(s) 102. These sensors, such as accelerometers and/or pressure sensors, can be mounted at various locations throughout the vehicle 10 selected to allow for sensing the particular vehicle condition for which the sensor is intended. In this description, the vehicle safety system 100 is described as including several crash sensors of different types and locations in the vehicle 10. This description is not limiting, as the vehicle safety system 100 can include any type of crash sensor, in any number, and in any location in the vehicle 10.

For example, the vehicle safety system 100 can include one or more active safety components, which can include frontal crash sensors 112 mounted forward in the vehicle 10 in the area, for example, of a front bumper (e.g., front-left and front-right). The active safety components can also include one or more rear crash sensors 114 mounted rearward in the vehicle 10 in the area, for example, of a rear bumper (e.g., rear-left and rear-right). The active safety components can also include one or more side sensors 116 mounted at driver and passenger side locations, such as in a vehicle door. Additionally, the active safety components can also include one or more rollover sensors 118 mounted at driver and passenger side locations, such as on a B-pillar of the vehicle 10.

The active safety components can optionally also include one or more cameras, radar, and other environment monitoring components identified generically at 115. It will be understood that multiple cameras can be positioned at various locations within and exterior to the vehicle for acquiring images of the vehicle interior and/or exterior. That said, the camera(s), radar, and other environment monitoring components 115 can be located at desirable locations on the vehicle (e.g., the front, rear, sides, roof, etc.). The environment monitoring components 115 generate signals indicative of the conditions sensed.

The locations of these various active safety components can be important in determining which amongst the various types of vehicle crash scenarios has taken place. This is referred to as crash discrimination. Not only is the position of the active safety components important, but their orientations is also important. Front and rear crash sensors 112, 114 can, for example, be positioned and oriented to measure acceleration in directions parallel to the vehicle X-axis. Side crash sensors 116 can, for example, be positioned and oriented to measure acceleration in directions parallel to the vehicle Y-axis. Rollover sensors are sensitive to accelerations in directions parallel to the vehicle Z-axis, but can be positioned and oriented to measure acceleration in directions parallel to the vehicle X, Y, and Z-axis.

Positioning the frontal crash sensors 112 in front-left and front-right locations in the vehicle 10 can help the airbag ECU 104 discriminate between a full-frontal collision, such as a “head-on” collision, from an offset or oblique frontal collision, such as frontal collisions where portions of the vehicles overlap or where the vehicles impact at an angle. Positioning rear crash sensors 114 in rear-left and rear-right locations in the vehicle 10 can provide discrimination similar to the front crash sensors 112 for rear crash scenarios. Side crash sensors, as implied by their name, are positioned in the vehicle side structure, such as in a vehicle door, and thereby can help discriminate side impact events. Rollover sensors 118 are positioned close to midway along the length of the vehicle 10 and can be positioned high in the vehicle, such as on a vehicle B-pillar. This positioning allows for measuring acceleration of the side structure in directions parallel to the Z-axis, and those accelerations can help discriminate the occurrence of a rollover event.

The remote sensors 112, 114, 116, and 118 aid in discriminating the type of crash event that has taken place. The vehicle safety system 100 can use these and/or other sensors (e.g., the environment monitoring components 115) to provide data that allows the airbag ECU 104 to make the threshold determination that a crash event has taken place. It is this determination that a crash event has taken place, in combination with the discrimination determination, that allows the airbag ECU 104 to determine which of the protection devices 102 to actuate and how to tailor their actuation, if necessary.

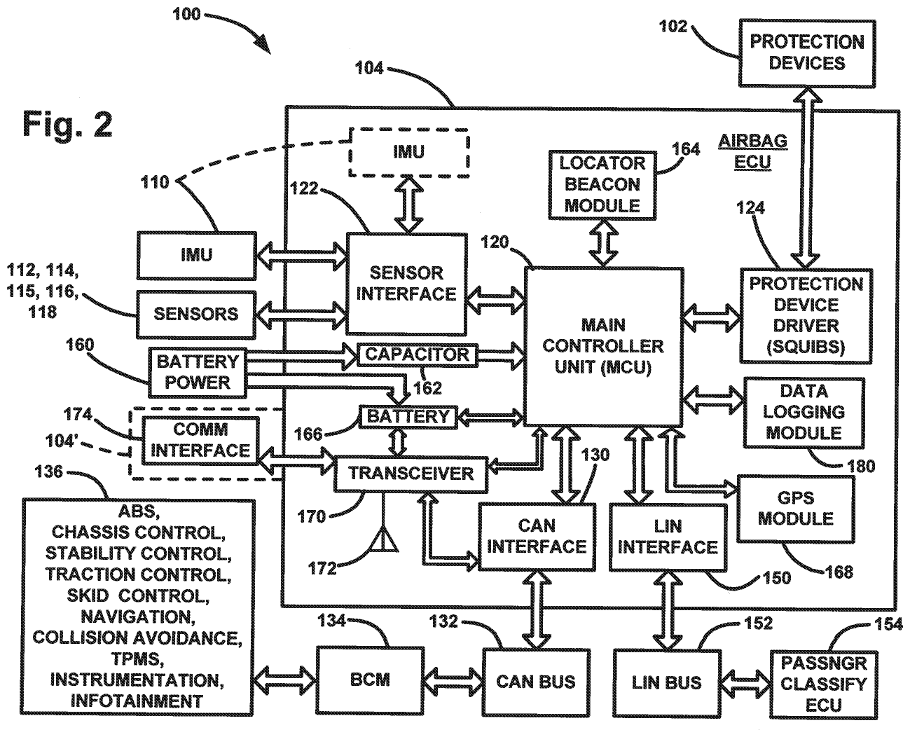

The sensors can also include an inertial measurement unit (IMU) sensor 110, which in one example is mounted at or near the vehicle center of gravity (COG), although other mounting locations in the vehicle are contemplated. In some implementations, the airbag ECU 104 itself can be mounted at or near the vehicle COG so, in these implementations, the IMU sensor 110 can be integrated into the airbag ECU (see, the IMU illustrated in dashed lines in FIG. 2). In fact, the IMU sensor 110 can include both inertial measurement sensors and crash sensors for detecting the occurrence of a vehicle crash condition. The crash sensors of the IMU sensor 110 can thus determine the occurrence of a crash, and the airbag ECU 104 can use measurements from the remote sensors 112, 114, 116, 118 to further discriminate the crash scenario.

Positioning the IMU sensor 110, whether by itself remotely from the airbag ECU 104 or integrated into the airbag ECU itself, at the vehicle COG is beneficial in that the sensor can provide accurate readings of sensed accelerations and roll motions. With respect to roll motions, the IMU sensor 110 provides data related to rotation parameters of the vehicle 10 about three principal axes (X, Y, Z). These parameters include:
Pitch—rotation about the vehicle Y-axis.
Yaw—rotation about the vehicle Z-axis.
Roll—rotation about the vehicle X-axis.
   Since crash indication can be best determined by measuring accelerations at or near the vehicle COG, and vehicle rotation indications are best measured about the vehicle X, Y, and Z axes, it can be advantageous to include both the crash sensors and the inertial measurement sensors in the IMU sensor 110.

Within the general framework illustrated in the vehicle 10 of FIG. 1, the vehicle safety system 100 is implemented and configured to cooperate with other vehicle systems. FIG. 2 illustrates an example configuration of the vehicle safety system 100. As shown in FIG. 2, the vehicle safety system 100 has a distributed architecture in which the airbag ECU 104 is not only connected to the remotely mounted crash sensors 110, 112, 114, 116, 118, and protection devices 102, but also to various other vehicle systems. FIG. 2 is intended to illustrate one such conventional distributed approach to occupant protection.

As shown in FIG. 2, the airbag ECU 104 includes a main controller unit (MCU) 120 configured to receive data and perform calculations necessary to determine whether a vehicle collision has occurred or about to occur and whether to actuate any of the vehicle occupant protection devices 102. The MCU 120 is operatively connected to a sensor interface 122 and to a protection device driver 124, for example, via internal serial bus connections, which facilitate high-integrity, fast and reliable communications between those components. The MCU 120 can also determine when other vehicle events besides a vehicle collision, e.g., vehicle theft or break-in, occur and operate one or more components associated with the MCU in response thereto.

The MCU 120 can be operatively connected to a CAN bus interface 130 that provides communication via a vehicle controller area network (CAN) bus 132. The CAN bus 132 facilitates communications between the vehicle safety system 100 and a vehicle body control module (BCM) 134. The BCM 134 can communicate via the CAN bus 132 with other vehicle systems 136, such as chassis control, stability control, traction/skid control, anti-lock braking (ABS), collision avoidance, tire pressure monitoring (TPMS), navigation systems, instrumentation (speed, throttle position, brake pedal position, etc.), information/entertainment (“infotainment”) systems, and other systems. Through the CAN bus interface 130, the airbag ECU 104 can communicate with any of these external systems 136 to provide and/or receive data.

The MCU 120 can also be operatively connected to a LIN bus interface 150 that provides communication via a vehicle local interconnect network (LIN) bus 152. This facilitates communications between the vehicle safety system 100 and systems or devices connected to the LIN bus 152, such as passenger classification systems 154, which obtain information via sensors 156, such as seatbelt switches, seat position sensors, seat weight sensors, and occupant position sensors.

The airbag ECU 104 is connected to vehicle battery power 160 which provides power to internal energy storage devices within the airbag ECU, namely, an internal capacitor 162 and a battery 166. The capacitor 162 is arranged in a circuit for powering the airbag ECU 104 in the event that vehicle battery power 160 is cutoff. More specifically, the capacitor 162 provides rapid power release to the MCU 120 so the protection device drivers 124 can be actuated as quickly as possible in response to detecting a crash event. That said, the vehicle battery power 160 and battery 166 are configured to ensure that power to the MCU 120 is continuous in case of a detected vehicle event (e.g., a detected vehicle crash, break-in or theft or a detected future/imminent vehicle crash based on vehicle sensors, cameras, etc.) to help ensure the performance and capabilities of the MCU are maintained.

Communication between the airbag ECU components, i.e., the MCU 120, sensor interface 122, protection device driver 124, CAN interface 130, and LIN interface 140 can be facilitated via an internal bus that provides both communication (e.g., serial communication) and power for driving their respective circuitries. In this respect, for example, the power supplied by the capacitor 162 to the protection device driver 124 can be used to energize the squibs that actuate the protection devices 102.

In operation, the remote sensors 110, 112, 114, 116, 118 sense their respective vehicle conditions and provide corresponding data streams to the sensor interface 122 of the airbag ECU 104. The sensor interface 122 passes the sensor data to the MCU 120, which implements control logic to determine whether the vehicle 10 is involved in a crash event for which deployment of any of the protection devices 102 is warranted. The sensors 112, 114, 116, 118 can be configured to provide raw crash data, such as raw-g data (for accelerometers) or relative pressure data (for pressure sensors). The MCU 120 performs calculations based on this data to determine whether to actuate any of the protection devices 102.

At the same time, the airbag ECU 104, being operatively connected to the BCM 134 via the CAN bus 132, can provide data to the BCM that is relevant to the operation of any other vehicle systems (e.g., active steering, skid control, suspension/stability control) whose operation may rely on that data.

When the vehicle 10 is involved in an event for which occupant protection is desired, such as a crash, collision, or rollover, the airbag ECU 104 senses the event by having the MCU 120 process information obtained from the crash sensors via the sensor interface 122. If the event reaches a threshold severity, the airbag MCU instructs the protection device driver 124 to actuate the protection devices 102 (e.g., via a “fire squibs” command). The firing command issued by the MCU 120 can be tailored or otherwise adjusted based on information obtained from the remote CAN bus 132 and LIN bus 152 connected devices, such as passenger classification and ABS data.

Distributing the components of the vehicle safety system 100 does, however, pose some issues. When the vehicle is involved in a collision, the vehicle battery power 160 can become unavailable to the airbag ECU 104. This can occur, for example, when mechanical and/or electrical connections become damaged or severed. The airbag ECU 104 can still function under these circumstances as it includes its own capacitor 162 for rapidly actuating the protection devices 102. Vehicle systems and components either outside the airbag ECU 104 or integrated therein, however, may not be capable of operating based on the capacitor 162 power and therefore can be lost when vehicle battery power 160 is lost. In such a case, even though the airbag ECU 104 can remain fully powered and functional to deploy the protection devices 102, its ability to access either the external systems or additional systems within/integral to the airbag ECU can be compromised.

Advantageously, as a feature of the vehicle safety system 100, the airbag ECU 104 is configured to be self-sufficient in providing a means for automatically communicating with emergency personnel in response to deploying the protection devices 102 when a crash event occurs or in response to another detected vehicle event, even when power to the vehicle battery 160 is severed or lost. In doing so, the airbag ECU 104 can function similar to the so called “black box” flight recorders used in the aviation industry. By this, it is meant that the airbag ECU 104 is configured to include all of the components necessary to render it self-sufficient in performing automated emergency communications (e.g., automatic crash/airbag deployment notification, call 9-1-1).

The airbag ECU 104 can also be self-sufficient in performing occupant communications (e.g., cellular communication with vehicle occupants), data recording (e.g., vehicle speed, throttle position, brake position, GPS location), and/or emergency functions (e.g., locator beacon functionality, communicating with emergency personnel or granting access/control of the vehicle to emergency personnel).

The self-sufficient configuration of the airbag ECU 104 is made possible, at least in part, by the internal battery 166, which powers select ECU components, and also by moving components facilitating this self-sufficiency onboard the airbag ECU 104, thereby eliminating their total reliance on vehicle battery power 160. These components can include a transceiver 170, a locator beacon module 164, a GPS location module 168, and a data logging module 180. In other words, the internal battery 166, in combination with the vehicle battery 160, ensures that power to the MCU 120 is continuous in case of a vehicle event, e.g., crash, theft, or break-in.

The term “module” in describing these components is meant merely to refer to the fact that they include electronics that cooperate to perform their described functions. This is not meant to state or imply that the “modules” are limited to packaged components or ASICs meant to perform these functions, although they could be. In fact, any of these “modules” 164, 168, 170, 180 can simply be portions of the circuitry, including ASICs and discrete components, for example, that are mounted on a common circuit board of the airbag ECU 104. That said, although the modules 164, 168, 170, 180 are schematically shown separately one or more of the modules 164, 168, 170, 180 can rely on other/common airbag ECU 104 circuitry or components and therefore be integrated with the ECU as opposed to a stand-alone, discrete component.

The transceiver 170 is powered directly by the battery 166 and facilitates communication with emergency personnel via a cellular connection (e.g., GSM, CDMA, LTE, etc.) utilized by an onboard antenna 172 connected to the transceiver 170. The antenna 172 can transmit data including vehicle GPS location, collision/crash time, and vehicle identifying information (e.g., make, model, color, license plate, etc.), all received by the various modules and interfaces in the airbag ECU 104 and capable of being powered by the battery 166 in the event vehicle power 160 is lost/severed/etc.

The transceiver 170 can offer cellular voice communication using free services (e.g., 9-1-1 emergency dialing only). Alternatively or additionally, the transceiver 170 can also be connected to or synchronized with the cellular phones of occupants in the vehicle 10. To enable normal, hands-free voice-activated or push-to-talk functionality. As another alternative or additional option, the transceiver 170 can implement onboard vehicle manufacturer communication services that feature push-to-talk customer service, roadside service requests, remote (e.g., cell phone) vehicle monitoring and unlock, emergency assistance and notification, etc.). For example, the transceiver 170 can be an OnStar module (GM), Sync module (Ford), UConnect module (Chrysler), Safety Connect/Enform module (Toyota), etc. The transceiver 170 can rely on these features directly through the antenna 172 or use the antenna to connect to the onboard cellular phones to use these features.

To increase the functionality of the transceiver 170, the module is operatively connected to a communication interface 174, which can include interface components such as speakers, microphones, and switches (e.g., push-to-talk and/or S.O.S. buttons). The microphones can be used by the vehicle occupants to send voice messages to emergency personnel. The speakers can broadcast messages from emergency personnel to the vehicle occupants and/or broadcast messages from the vehicle to the vehicle occupants. The communication interface 174 can exchange data with the transceiver 170 either through wires or wirelessly.

The implementation of these devices is not trivial, given the fact that the airbag ECU 104 is configured to be self-sufficient and operate without vehicle battery power 160. Because of this, the communication interface 174 is powered through the airbag ECU 104 and its operation, at least for “in the event of an emergency” scenarios, is self-supported and continuously maintained. The communication interface 174 and its components (speaker, microphone, pushbutton) can therefore be considered part of the airbag ECU itself, as indicated generally by the dashed lines at 104′. That said, the communication interface 174 can include its own internal battery (not shown) similar to the battery 166 or be electrically connected to the battery 166 (not shown).

Additionally, so as to avoid redundant components while maintaining the self-sufficient integrity of the airbag ECU 104, the transceiver 170 can also be operatively connected to the CAN interface 130. This allows the transceiver 170 to communicate with external systems via the CAN bus 132 and/or the BCM 134 so that those systems can interface the vehicle occupants/operator via the transceiver. This can, for example, enable communication with navigation and infotainment systems (see vehicle systems 136) via the transceiver 170.

This configuration is beneficial in that it eliminates the duplication of hardware because the components of the communication interface 174 can be used for emergency communication functions of the airbag ECU 104 in a self-sufficient manner, and also for routine communications facilitating the information, entertainment, navigation, etc. functions of the infotainment and navigation systems 136. In other words, the battery 166 can power the interface 130 and vehicle systems 136 in the event vehicle battery power 160 is lost.

It will be appreciated that one or more of the sensors 112, 114, 115, 116, 118 and/or communication interface 174 (including the speakers, microphones, and switches) can also be provided with emergency power in the event vehicle batter power 160 is lost. This emergency power can be provided by the battery 166 or one or more additional internal batteries (not shown) provided on the airbag ECU 104. That said, any number of the sensors 112, 114, 115, 116, 118 can be provided on the airbag ECU 140 and therefore considered part thereof.

Advantageously, locating the transceiver 170 within the airbag ECU 104 allows the MCU 120 to use the squib fire command (e.g., actuating the protective device driver 124) as the trigger for issuing an emergency message through the transceiver 170. Because the MCU 120 controls the protection device driver 124, the emergency message generation can be simultaneous with protection device actuation. In other words, in response to detecting a crash event, the airbag ECU 104 sends a signal to the protection device driver 124 to activate the protection devices 102 while simultaneously activating the transceiver 170 to generate the emergency message to be sent by the antenna 172 to an outside source (e.g., emergency personnel, designated cell phones outside the vehicle, other vehicles participating in traffic in the area of the crash event, infrastructure in the vicinity of the crash event, etc.).

The emergency message can be generated and sent when any vehicle event is detected. That said, when the vehicle event is a vehicle crash in which a protection device is not deployed (e.g., a rear-end collision, a theft or break-in) actuation of the protection device driver 124 does not occur. In such cases, the MCU 120 detects the vehicle event [or that the vehicle event is about to occur based on the sensors/cameras/etc.] and generates/sends the emergency message. The MCU 120 can also switch power from the vehicle battery 120 to the battery 160 prior to the vehicle event occurring when such vehicle event is detected in advance to ensure continuous power/functionality to the MCU.

Since the emergency message generation and transmission is self-contained within the airbag ECU 104, and is triggered through wholly contained airbag ECU components, there is no need for any external triggers or communication with other systems. Therefore, the risk that the emergency message is not sent is reduced, even in the most severe vehicle crash scenarios. Moreover, since the protection device driver 124 is actuated at the same time that the emergency message is sent, the risk that “false” or inadvertent emergency communications (e.g., emergency communications sent when no crash event has occurred) is reduced.

The locator beacon module 164 is an optional feature that can further provide assistance in an emergency, i.e., vehicle crash situation, by helping to ensure the original emergency call was not missed by emergency personnel. The locator beacon 164 serves as a near-field locator function and can have various implementations. For example, the locator beacon 184 can be audible, such as an audible periodic ping, that can be heard from distances and used to locate the vehicle in the event that the vehicle is involved in an off-road crash incident. The locator beacon 164 can be automatically actuated by emergency personnel on-scene to provide location assistance (e.g., to later arriving emergency personnel).

Alternatively or additionally, the locator beacon module 164 can include a Sarsat locator beacon module. Sarsat is an international, humanitarian search and rescue system that uses satellites to detect and locate emergency beacons typically carried by ships, aircraft, or individuals. The system consists of a network of satellites, ground stations, mission control centers, and rescue coordination centers. When an emergency beacon is activated, the signal is received by a satellite and relayed to the nearest available ground station. The ground station processes the signal and calculates the position from which it originated. This position is transmitted to a mission control center where it is joined with identification data and other information on that beacon. The mission control center then transmits an alert message to the appropriate rescue coordination center based on the geographic location of the beacon.

Implementing a 406 MHz beacon, a distress message can be sent to the appropriate authorities from anywhere on Earth 24 hours a day, 365 days a year. Although Sarsat locator beacon functionality may not be necessary for the typical automobile owner, the functionality could be beneficial in specialty vehicles, such as off-road vehicles, military vehicles, and exploration vehicles. In any matter, implementing a Sarsat locator beacon module 164 in the airbag ECU 104 would advantageously improve its standalone, “vehicle black box” configuration.

The data logging module 180 is another optional module that can be included in the airbag ECU 104 to further enhance its standalone, “vehicle black box” configuration. While some vehicles may record certain information, such as vehicle speed, throttle position, brake position, ABS information, stability/traction/skid control information, etc., that information is located remote from the airbag ECU 104. Depending on factors such as crash severity, data logging may cease if vehicle battery power 160 is lost, which could result in information desirable for emergency personnel being lost. This information could be crucial to painting a complete picture in terms of crash reconstruction. By placing this functionality in a self-sufficient, self-powered airbag ECU 104, the data logging module 180 can continue to record data long after the crash occurs and the protection devices 102 are deployed—even in the event of vehicle battery power 160 disconnection. In other words, the data logging module 180 can be powered by the battery 166.

The GPS module 168 is another optional module that can be included in the airbag ECU 104 and is configured to obtain GPS location data from satellites indicative of the location of the vehicle 10 in real-time. The airbag ECU 104 can continuously receive data from the GPS module 168 and, in response to detecting a crash event, process the GPS data such that the transceiver 170—via the antenna 172—can transmit the GPS data to emergency personnel to help locate the vehicle 10 even in the event of vehicle battery power 160 disconnection or loss.

Additionally, the airbag ECU 104 can be configured to grant emergency personnel access and control of the vehicle safety systems once the emergency notification is received. In other words, the emergency notification transmitted by the transceiver 170 can include a password or other information that allows the receiver of the emergency notification (e.g., emergency personnel) to access and control certain vehicle functions following a vehicle crash. This can include, but is not limited to, the airbag ECU 104, cameras, microphones, speakers, any occupant cell phones synchronized with the airbag ECU or other vehicle systems and components that can be beneficial to the emergency personnel receiving the emergency notification. The emergency message can be encrypted and only allow access and/or control of the vehicle if permission is granted by a key held by qualified emergency personnel. The access and/or control can be severed after a predetermined amount of time, after certain vehicle functions are performed or when the emergency personnel or vehicle operator directs the MCU 120 to sever the connection (e.g., via console button or verbal command). The access and/or control can be re-established under the same conditions discussed for initially establishing the connection.

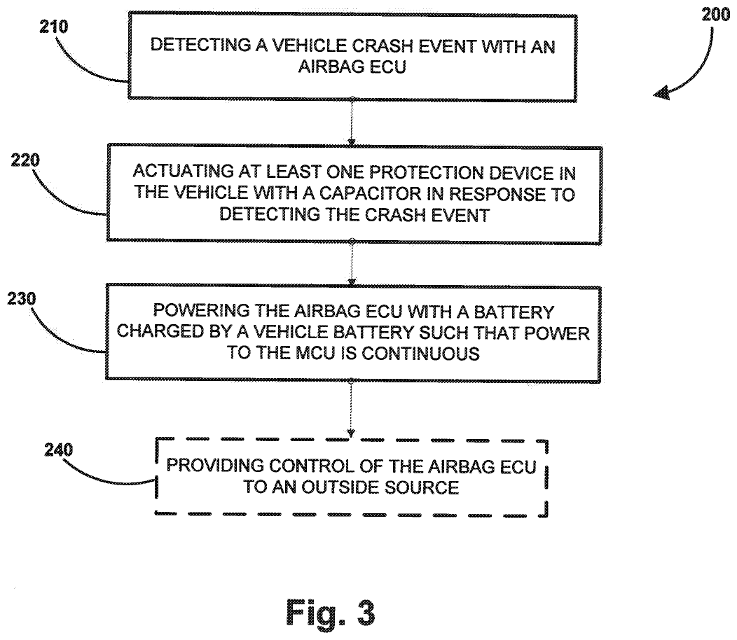

An example method 200 of operating the airbag ECU 104 is shown in FIG. 3. In step 210, the airbag ECU 104 detects the occurrence of a vehicle crash event (e.g., by relying on various sensors and/or cameras around the vehicle). In step 220, the airbag ECU 104 actuates at least one airbag 102 using the on-board capacitor 162 in response to detecting the crash event. In step 230, the battery 166 powers the airbag ECU 104 when power to the vehicle battery 160 is lost. The method 200 can optionally also include the step 240 of providing control of the airbag ECU 104 to an outside source. This optional step can include with or without vehicle power being lost.

From the above description of the invention, those skilled in the art will perceive improvements, changes and modifications. Such improvements, changes and modifications within the skill of the art are intended to be covered by the appended claims.

Having described the invention, the following is claimed:

1. An airbag electronic control unit (ECU) for a vehicle, comprising:
a main controller unit (MCU) for, in response to detecting a vehicle event, actuating at least one protection device in the vehicle; and
a battery for receiving power from the vehicle to power the MCU such that power to the MCU is continuous.

2. The airbag ECU recited in claim 1 further comprising a capacitor electrically connected to the MCU for actuating the at least one protection device in response to a detected vehicle event.

3. The airbag ECU recited in claim 1, wherein the vehicle event comprises at least one of a vehicle crash, a vehicle theft or a vehicle break-in.

4. The airbag ECU recited in claim 1 further comprising:
a transceiver connected to the MCU and the battery; and
an antenna connected to the transceiver for sending information received by the transceiver to a source outside the MCU.

5. The airbag ECU recited in claim 4, wherein the information comprises an automatic emergency notification executed by the transceiver and sent by the antenna to the source in response to the detected vehicle event.

6. The airbag ECU recited in claim 5, wherein the automatic emergency notification includes at least one of a vehicle collision time, a vehicle location, and vehicle identifying information.

7. The airbag ECU recited in claim 5, wherein the automatic emergency notification comprises a GPS location of the vehicle.

8. The airbag ECU recited in claim 1 further comprising a GPS module connected to the MCU and the battery.

9. The airbag ECU recited in claim 1 further comprising an external communication interface operatively connected to the MCU and comprising:
at least one microphone for receiving voice communications from an occupant of the vehicle; and
at least one speaker for broadcasting messages to the vehicle occupant.

10. The airbag ECU recited in claim 9, wherein the MCU is configured to receive and transmit voice commands from an occupant of the vehicle for operating at least one in-vehicle system other than a vehicle safety system in response to detecting the vehicle event.

11. The airbag ECU recited in claim 10, wherein the at least one in-vehicle system comprises chassis control, stability control, traction/skid control, anti-lock braking, collision avoidance, tire pressure monitoring, navigation systems, instrumentation systems, and infotainment systems.

12. The airbag ECU recited in claim 10, wherein the MCU is configured to provide in-cabin voice recognition commands for at least one of hands-free dialing systems, hands-free navigation systems, hands-free entertainment systems, and hands-free manufacturer-based communication systems in response to detecting the vehicle event.

13. The airbag ECU recited in claim 1 further comprising at least one camera connected to the MCU for acquiring images of at least one of the vehicle interior and vehicle exterior in response to detecting the vehicle event.

14. A method of operating an airbag ECU, comprising the steps of:
detecting a vehicle crash event with a MCU;
actuating at least one protection device in the vehicle with a capacitor on the airbag ECU in response to detecting the crash event; and
powering the airbag ECU with a battery charged by a vehicle battery such that power to the MCU is continuous.

15. The method recited in claim 14, wherein the airbag ECU is powered by the battery prior to actuating the at least one protection device.

16. The method recited in claim 14 further comprising providing control of the airbag ECU to an outside source in response to detecting the crash event.

17. The method recited in claim 16, wherein control of the airbag ECU is provided to an outside source in an encrypted manner.

18. The method recited in claim 14 further comprising providing control of vehicle occupant cell phones synchronized with the airbag ECU to an outside source in response to detecting the crash event.

19. The method recited in claim 14 further comprising sending an automatic emergency notification to a source outside the vehicle with a transceiver in response to detecting the crash event.

20. The method recited in claim 19, wherein the automatic emergency notification includes at least one of a vehicle collision time, a vehicle location, and vehicle identifying information.

21. The method recited in claim 14 further comprising:
obtaining a GPS location of the vehicle; and
transmitting the GPS location to an outside source in response to detecting the crash event.

22. The method recited in claim 14 further comprising:
synchronizing the airbag ECU with a cell phone of a vehicle occupant;
communicating with the synchronized cell phone in response to detecting the crash event in order transmit data to and from the vehicle; and
severing the communication between the synchronized cell phone and the airbag ECU.

23. The method recited in claim 14 further comprising at least one of:
receiving voice communications from an occupant of the vehicle with a microphone; and
broadcasting messages to the vehicle occupant with a speaker.

24. The method recited in claim 14 further comprising transmitting a periodic emergency beacon in response to detecting the crash event that includes at least one of a collision time, a vehicle location, and vehicle identifying information.

25. A method of operating an airbag ECU, comprising steps of:
supplying power to the ECU from a power supply outside the ECU;
determining when power from the power supply is lost;
directing power from a battery on-board the ECU to the ECU to maintain continuous operation of the ECU.
